(19) United States
(12) Patent Application Publication
(10) Pub. No.: US 2021/0042742 A1
(43) Pub. Date: Feb. 11, 2021

(54) SYSTEM AND METHOD FOR GENERATING TIME-SERIES TOKEN DATA

(71) Applicant: Capital One Services, LLC, McLean, VA (US)

(72) Inventors: Katherine McHUGH, Richmond, VA (US); Marcus PARE, Henrico, VA (US); Shahzheeb KHAN, Glen Allen, VA (US)

(73) Assignee: Capital One Services, LLC, McLean, VA (US)

(21) Appl. No.: 16/536,468

(22) Filed: Aug. 9, 2019

(51) Int. Cl. G06Q 20/38; G06F 16/25

(52) U.S. Cl. CPC G06Q 20/3821; G06F 16/254

(57) ABSTRACT

Described herein is a system for capturing time-series token data. The system may receive messages from a financial network. Each message may be generated based on an event affecting the payment device. Each of the messages include a token tied to an external system and metadata. The token and metadata may be extracted from the messages. Each of the token and metadata may be stored in a local vault. The local vault may correlate each event to the token affected by the event. Time-series token data may be captured for each token based on based on the metadata of the respective token. The time-series token data includes events tied to each token. An account holder may manage all of the token information from a central location.

### BACKGROUND

Various entities, such as retailers or service providers, store payment information for account holders. The payment information may include a payment device (e.g., credit card, debit card, gift card, or the like) number, expiration date, billing address, etc. Storing the payment number in a database may cause security issues. Therefore, each entity may execute payment tokenization to store the payment information.

Tokenization is the process of protecting sensitive data (e.g., payment information) by replacing it with an algorithmically generated number called a token. Tokens may be randomized alphanumeric strings. The account holder's payment device number, or a primary account number (PAN), is replaced with a series of randomly-generated numbers, referred to as the “token.” These tokens may then been passed through the internet or the various wireless networks needed to process the payment without the payment device details being exposed. The payment device number is safely stored in a secure token vault.

Each entity may generate a different token for the same payment device of the account holder. The financial institution issuing the payment device may need to access the token information stored at various entities for the respective account holders. Conventionally, to achieve this, the financial institution would have to individually query an application program interface (API) of the respective entity each time the financial institution needed to retrieve the token information. This is may be a cumbersome process which uses a lot of computational resources.

### BRIEF DESCRIPTION OF THE FIGURES

The accompanying drawings, which are incorporated herein and form part of the specification, illustrate the present disclosure and, together with the description, further serve to explain the principles of the disclosure and enable a person skilled in the relevant art to make and use the disclosure.

FIG. 1 is a block diagram of an example environment in which systems and/or methods for capturing time-series token data, according to some embodiments.

FIG. 2 illustrates example graphical user interfaces (GUIs) of a local vault interface, according to some embodiments.

FIG. 3 illustrates a flow of data of the system for capturing time-series token data, according to some embodiments.

FIG. 4 is a flowchart illustrating a process for capturing time-series token data, according to some embodiments.

FIG. 5 is a flowchart illustrating a process for generating an interface for managing the time-series token data, according to some embodiments.

FIG. 6 is a block diagram of example components of device, according to some embodiments.

The drawing in which an element first appears is typically indicated by the leftmost digit or digits in the corresponding reference number. In the drawings, like reference numbers may indicate identical or functionally similar elements.

### DETAILED DESCRIPTION

Described herein is a system for capturing time-series token data. External systems of entities such as retailers, merchants, service providers and the like may process and store payment device information, such as credit card information, debit card information, pre-paid debit card information, gift card information, or the like. To securely store the payment device information the external systems may perform tokenization to generate tokens representing the payment device of an account holder. The token may be an alphanumeric string unique to the external system. The external system may initially store the payment device using and correlate the token to the payment device. The external system may subsequently retrieve the payment device using the token.

A financial institution issuing the payment device may receive messages from a financial network. Each message may be generated based on an event affecting the payment device. Each of the messages may include a token tied to an external system and metadata. The token and metadata may be extracted from the messages. Each of the token and metadata may be stored in a local vault. The local vault may correlate each event to the token affected by the event. Time-series token data may be captured for each token based on based on the metadata of the respective token. The time-series token data includes events tied to each token. An account holder may manage all of the token information from a central location.

The aforementioned configuration may allow for maintaining all of an account holder's token information in a central location. This may eliminate having to repeatedly make a call to an API of a financial network to retrieve token data for a payment device for various external systems. Repeatedly calling the API of a financial network may be a cumbersome and computationally expensive process. In this regard, the system for capturing time-series token data may solve the technical problem of reducing the calls to an API of a financial network for retrieving token data for a payment device, and in-turn may reduce the amount of computational resources necessary to manage and store token data.

Furthermore, the system for capturing time-series token data may be used to build analytical models. The analytical models may be used in machine-learning algorithms to forecast, predict, and detect events, such as fraud or suspicious activity. In view of this by being able to manage and store the token data from various distributed external systems in central location, the system for capturing time-series token data may allow for security when the tokens are used by being able to forecast, predict, and detect events, such as fraud or suspicious activity.

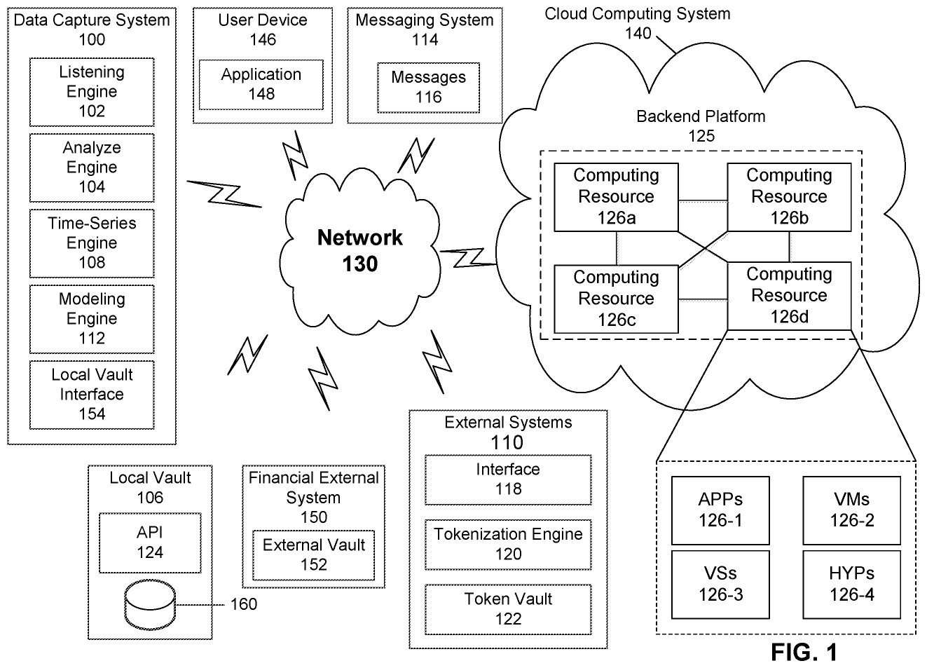

FIG. 1 is a block diagram of an example environment in which systems and/or methods for capturing time-series token data according to an example embodiment. The environment 100 may include a data capture system 100. The data capture system 100 may include a listening engine 102, an analyze engine 104, a time-series engine 108, and a modeling engine 112. Environment 100 may further include a local vault 106, an external system 110 messaging system 114, a user device 146, and a financial network 150.

Local vault 106 may include a self-contained environment including an API 124 and a relational database 160.

Data capture system 100 may interface with the local vault 106 using API 124.

Messaging system 114 may include messages 116.

Financial network 150 may include an external vault 152. Local vault 106 and external vault 152 may be self-contained environments configured to store sensitive information such as payment device information and the respective tokens.

Data capture system 100, local vault 106 and messaging system 114 may be hosted by a financial institution configured to issue payment devices, such as credit card, debit cards, pre-paid debit cards, gift cards, and/or the like.

Listening engine 102 may be a listener configured to detect new messages as they are received by the messing system 114.

The devices of the environment 100 may be connected through wired connections, wireless connections, or a combination of wired and wireless connections.

Data capture system 100, external system 110 messaging system 114, user device 146, and financial network 150 may reside within the cloud computing environment 140. Alternatively, data capture system 100, external system 110 messaging system 114, user device 146, and financial network 150 may reside outside the cloud computing environment 140.

In an example embodiment, one or more portions of the network 130 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The backend platform 125 may include a server or a group of servers. In an embodiment, the backend platform 125 may be hosted in a cloud computing environment 140. It may be appreciated that the backend platform 125 may not be cloud-based, or may be partially cloud-based.

The cloud computing environment 140 may include an environment that delivers computing as a service, shared resources, services, etc. . . . . The cloud computing environment 140 may provide computation, software, data access, storage, and/or other services that do not require end-user knowledge of a physical location and configuration of a system and/or a device that delivers the services. The cloud computing system 140 may include computer resources 126.

Each computing resource 126a-d may include one or more personal computers, workstations, computers, server devices, or other types of computation and/or communication devices. The computing resource(s) 126a-d may host the backend platform 125. The cloud resources may include compute instances executing in the cloud computing resources 126a-d. The cloud computing resources 126a-d may communicate with other cloud computing resources 126a-d via wired connections, wireless connections, or a combination of wired or wireless connections.

Computing resources 126a-d may include a group of cloud resources, such as one or more applications (“APPs”) 126-1, one or more virtual machines (“VMs”) 126-2, virtualized storage (“VS”) 126-3, and one or more hypervisors (“HYPs”) 126-4.

Application 125-1 may include one or more software applications that may be provided to or accessed by the user device 146. In an embodiment, the application 148 may execute locally on the user device 146. Alternatively, the application 126-1 may eliminate a need to install and execute software applications on the user device 146. The application 126-1 may include software associated with backend platform 125 and/or any other software configured to be provided across the cloud computing environment 140. The application 126-1 may send/receive information from one or more other applications 126-1, via the virtual machine 126-2.

Virtual machine 126-2 may include a software implementation of a machine (e.g., a computer) that executes programs like a physical machine. Virtual machine 126-2 may be either a system virtual machine or a process virtual machine, depending upon the use and degree of correspondence to any real machine by virtual machine 126-2. A system virtual machine may provide a complete system platform that supports execution of a complete operating system (OS). A process virtual machine may execute a single program and may support a single process. The virtual machine 126-2 may execute on behalf of a user (e.g., user device 140) and/or on behalf of one or more other backend platforms 125, and may manage infrastructure of cloud computing environment 140, such as data management, synchronization, or long duration data transfers.

Virtualized storage 126-3 may include one or more storage systems and/or one or more devices that use virtualization techniques within the storage systems or devices of computing resources 126a-d. With respect to a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how administrators manage storage for end users. File virtualization may eliminate dependencies between data accessed at a file level and location where files are physically store. This may enable optimization of storage use, server consolidation, and/or performance of non-disruptive file migrations.

Hypervisor 126-4 may provide hardware virtualization techniques that allow multiple operations systems (e.g., “guest operating systems”) to execute concurrently on a host computer, such as computing resources 126a-d. Hypervisor 126-4 may present a virtual operating platform to the guest operating systems, and may manage the execution of the guest operating systems multiple instances of a variety of operating systems and may share virtualized hardware resource.

In an embodiment, a financial institution hosting messaging system 114 and data capture system 100 may issue a payment device to an account holder. The payment device may be tied to a specific financial network. The account holder may use the payment device at various external systems 110. External system 110 may include an interface 118 for executing actions related to the payment device. For example, external system 110 may be a retailer or service provider which stores and process payment devices (e.g., credit cards, debit cards, pre-paid debit cards, gift cards, or the like) in response to the account holder providing the payment device information and executing an event (e.g., sale, return, addition of payment device, deletion of payment device, deletion of an account, modification of the account or payment device, or the like) with the payment device using interface 118 of external system 110.

External system 110 may use a tokenization engine 120 to execute tokenization for the payment device information. As described above, a token is a randomized alphanumeric string representing the payment device identifier (e.g., credit card number, debit card number, gift card number, or the like). External system 110 may store the payment device information and tokens in the token vault 122. External system 110 may retrieve the payment device information from token vault 122 when the same account holder executes a different transaction, using the token. Each different external system 150 may generate and store a different token for the same payment device and account holder.

An account holder may execute various actions to their payment device using interface 118. As an example, an account holder may view, use, suspend, delete, or add a payment device with respect to the specific external system. Each action may cause a creation of an event and a message to be sent to a financial network 150 (e.g., VISA, MASTERCARD, AMERICAN EXPRESS, DISCOVER, or the like) associated with the payment device. In response to the event, financial network 150 may receive the token generated by the respective external system and the event information.

Financial network 150 may transmit a message to messaging system 114 hosed by a financial institution which issued the payment device. The message may include the token generated by the respective entity and metadata, so that the financial institution may process the event. Metadata may include, but is not limited to, payment device identifier, payment account reference, date and time stamp, token requestor ID, message type, token reference ID, device name, payment network identifier, secure element identifier, account hash, IP address of user device 146, user device 146 location (latitude/longitude), user device ID, token status (e.g., active, deactivated, suspended, or inactive), token type, event type, reason code, and other relevant information. The messages may be stored in a messages repository 116.

Payment device identifier may be a credit card number, debit card number, pre-paid debit card number, or the like. Date and time stamp may be the date and time messaging system 114 received the message. Response code may indicate whether the payment device as approved. Message type may indicate the type of message (e.g., token activation, creation, completion). Token reference identifier may indicate an identifier of the payment network (e.g., financial network), issuer identifier, external system identifier, a unique identifier allocated to the token, or a fixed value indicating a token. Token type may indicate the usage category of tokens. There may be two main types of tokens—device related and network-card-on-file. The device related tokens may be generated as part of device wallet (e.g., APPLE PAY) provisioning. The network-card-on-file type may represent the tokens that are generated by the networks (VISA/MASTERCARD) on behalf of an external system. PAN reference identifier may indicate fixed value indicating primary account number (e.g., payment device identifier), external system identifier, issuer identifier, unique identifier allocated to the primary account number for this tokenization event. A secure element may be a tamper-resistant platform (e.g., a one chip secure microcontroller) capable of securely hosting applications and their confidential and cryptographic data (e.g., key management) in accordance with the rules and security requirements set forth by a set of well-identified trusted authorities. The identifier may be the unique ID that corresponds to the devices secure element. Device name may be a name that the account holder has assigned to the user device 146 with the external system 110. An account hash may be a hash value of the account ID set by the external system.

Listening engine 102 may detect that a messaging system has received a new message. Listening engine 102 may alert the analyze engine 104 of the new message received by messaging service 114. Analyze engine 104 may interface with messaging system 114 to extract the token and metadata from the message. Analyze engine 104 may validate format the token and metadata. For example, the metadata may include a date. Analyze engine 104 may validate the format of the date. Analyze engine 104 may call API 124 of the local vault 106 to interface with local vault 106. Analyze engine 104 may store the token and metadata in the local vault 106. Local vault 106 may store the token and metadata in relational database 160. Local vault 106 may correlate the token and metadata with the account holder. In this regard, local vault 106 may store each of the tokens generated by the various external systems 110 for the payment device of the account holder and information for each of the events executed by the account holder overtime with respect to each token.

Time-series engine 108 may capture time-series data and generate a time-series model detailing all of the account holder's tokens and events executed with the respective tokens. For example, a time-series model may illustrate events such as creation of an token at an external system 110, use of the token by the external system 110 to execute a transaction, deletion of the token, suspension of the token, modification of the token, and use of the token, over a snapshot in time.

Modeling engine 112 may generate an analytical or predictive model using the time-series data. The analytical or predictive models may be used to detect or predict events such as detect fraud, lost or stolen payment devices, or the like. As an example, the analytical or predictive model may detect suspicious activity based on location of an event associated with a token based on a known location of the account holder. As another example, the analytical or predictive model may detect suspicious activity based on the type of external system 110 which generated the token, as the analytical or predictive model may indicate that the type of external system 110 is different than the types of external systems 110 normally used by the account holder. Modeling engine 112 may use machine learning algorithms to generate the analytical or predictive models.

An account holder may access local vault interface 154 using application 148. Local vault interface 154 may provide a graphical user interface to the account holder which depicts all of the tokens and respective information stored by the local vault 106 for the specific account holder and their respective payment devices. The account holder may view, create, modify, or delete payment devices for various external systems 110, using local vault interface 154. Local vault interface 154 may interface with the various external systems 110 to view, create, modify, or delete the account holder's payment devices.

As a non-limiting example, external system 110 may be a retailers and an account holder may use interface 118 of external system 110 to purchase retail items using the account holder's payment device. The attempt to purchase retail items using the payment device may be an event. External system 110 may generate a token for the account holder's payment device using tokenization engine 120 and store the payment device information along with the token in token vault 122.

To process the sale, external system 11 may generate and transmit a message to financial network 150. Financial network 150 may transmit a message to message system 114 hosted by the financial institution configured to process the payment of the sale. Messaging system 114 may receive the message which includes the token and metadata.

Listening engine 102 may detect the message received by messaging system 114 and may extract the token and metadata from the message. Listening engine 102 may alert analyze engine 104 of the new message received by messaging system 114. Analyze engine 104 may extract the token and metadata from the message. Analyze engine 104 may call API 124 of the local vault 106 to interface with local vault 106. Analyze engine 104 may validate the format of the token and metadata from the message and store the token and metadata in local vault 106. The token and metadata may be correlated with the account holder. Local vault 106 may store each event generated by external system 110 of the retailer for using the account holder's payment device. Each event originating at the external system 110 may be tied to the token generated by external system 110 of the retailer.

Time-series engine 108 may capture time-series data and may generate a time-series model based on the token and metadata for an account holder's payment device stored in the local vault 106. For example, the time-series data may include all of the events for a payment device, associated with the retailer's external system 100 over a period of time. The events may include creation of the token, use of the token, suspension of the token, deactivation of the token, and/or the like. Modeling engine 112 may generate analytical or predictive models using the time-series data.

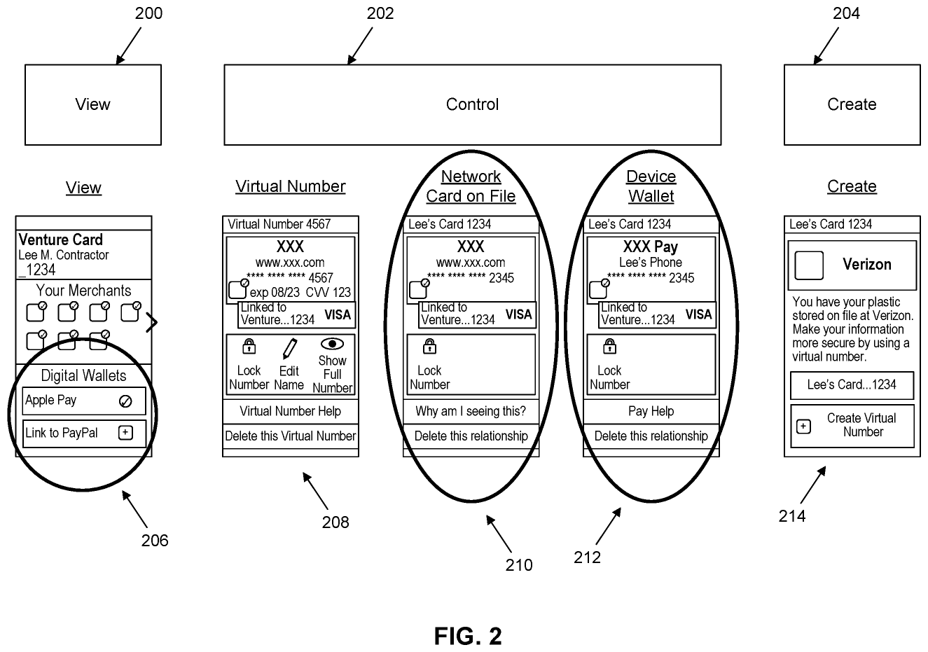

FIG. 2 illustrates example graphical user interfaces (GUIs) of a local vault interface according to an example embodiment. The local vault interface may provide a central location in which an account holder may manage their payment device and various external systems in which the payment device is used. The local vault interface may render GUIs for managing a payment device in which the account holder may view, control, or create tokens for a payment device.

As a non-limiting example, GUIs may include a view GUI 200, a control GUI 202, and a create GUI 104. View GUI 200 may render a view 206 indicating all of the merchants using the payment device of the account holder along with digital wallets using the payment device. An account holder may select any merchant or digital wallet to control the use of the payment device.

Control GUI 202 may include a view 208 to control an account holder's virtual number used by an external system which is a service provider (e.g., SPOTIFY), a view 210 to control an account holder's network card on file used by an external system which is a service provider (e.g., NETFLIX), and a view 212 to control an external system which is a digital wallet using the account holder's payment device (e.g., APPLEPAY). An account holder may lock the virtual number, edit nickname, and show full number using view 208. An account holder may lock their network card on file using view 210. An account holder may lock the payment device used by the digital wallet using view 212. An account holder may also delete relationships with the service providers or digital wallet using views 208-212.

Create GUI 204 may include view 214 for creating a relationship with the payment device and an external system which is a service provider (e.g., VERIZON). The account holder may use view 214 to load a payment device to use with a service provider. The account holder may use view 214 to create a virtual number for the payment device to be used by the service provider.

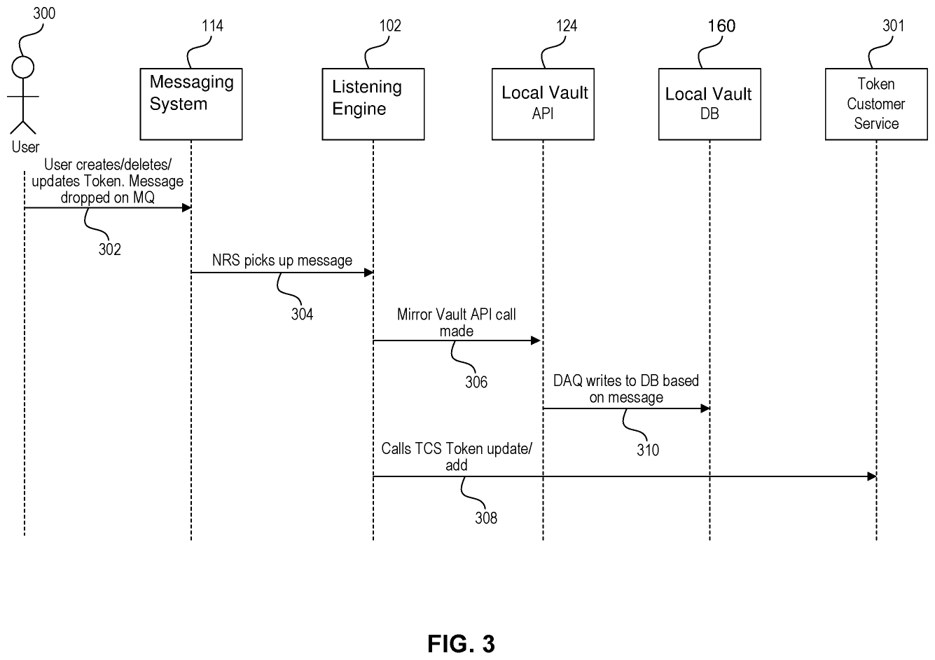

FIG. 3 illustrates a flow of data of the system for capturing time-series token data according to an exemplary embodiment. It is to be appreciated the operations may occur in a different order, and some operations may not be performed. Merely as an example, the flow of data will be described with respect to FIG. 1.

In operation 302, user (i.e., account holder) 300 may create/delete/update a token for a payment device. The create/delete/update token message may be received by the messaging system 114.

In operation 304, listening engine 102 may detects the messaging system 114 has received the message. Analyze engine 104 may parse and extract the token and metadata from the message.

In operation 306, analyze engine 104 may call API 124 (e.g., local vault API) of local vault 106 to interface with the local vault 106.

In operation 308, analyze engine 104 may also call the token customer service to update or add the token for the account holder's payment device. Token customer service may be a hub for managing network tokens provided by financial networks. Token customer service may be an API which allows retrieval/update of network tokens. Token customer service may send emails to customers whenever a provisioning event occurs for one of their cards, and/or the like. In operation 310, analyze engine 104 stores the token and metadata in relational database 160 (e.g., local vault DB) of the local vault 106.

Local vault 106 may provide for adding a token, retrieving all tokens for an account holder's payment device, retrieve a token for an account holder's payment device for a specified external system, and retrieving token history for an account holder's payment device for one or more external systems.

To add a token, local vault 106 may receive a request for storing token data and metadata including, the token, payment device number, token type, token status, account ID, device information from which the token is being created, event type, event reason, a message reason code, and other relevant information.

To retrieve all token data, local vault 106 may receive a query request for retrieving all token and metadata for an account holder's payment device. The response from local vault 106 may include token summary of all the tokens used by all the external systems, account ID, device information from which the request originated, payment device identifier, and other relevant information.

To retrieve a token for a toke used by a specified external system, local vault 106 may receive a query request for retrieving a token for a specified external system. The response from local vault 106 may include the token, account ID, device information from which the request originated payment device identifier, and other relevant information.

To retrieve a token history for tokens used by one or more external systems, local vault 106 may receive a query request for retrieving token history for tokens used by one or more external systems. The response from local vault 106 may include all of the events pertaining to the token of each external system including information such as event reason, event requestor, event type, message reason code, message type, token type, and other relevant information. The events may be creation, modification, suspension, deactivation, deletion or other actions affecting the token used by an external system.

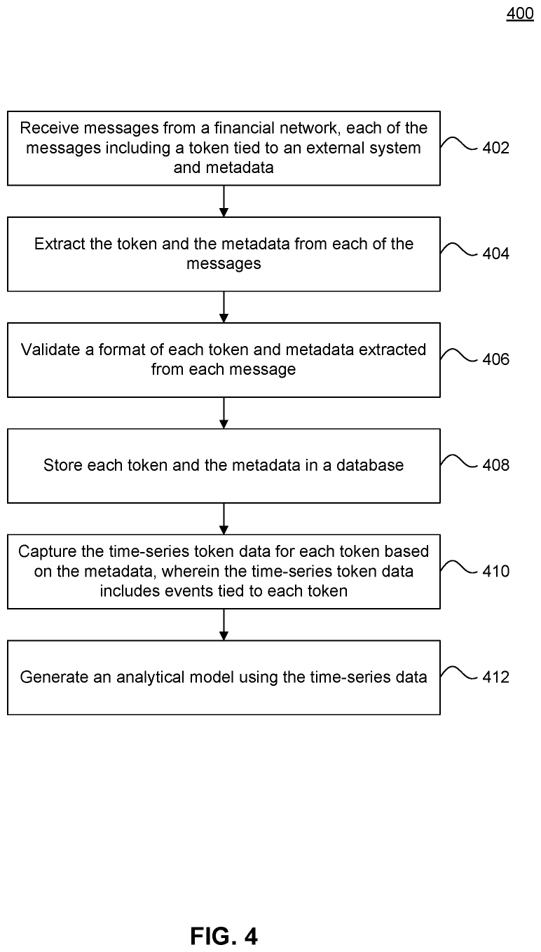

FIG. 4 is a flowchart 400 illustrating a process for capturing time-series token data. It is to be appreciated the operations may occur in a different order, and some operations may not be performed. Merely as an example, the flow of data will be described with respect to FIG. 1.

Flowchart 400 starts at operation 402. In operation 402, a messaging system may receive messages from a financial network. The messaging system may be hosted by a financial institution which is the issuer of a payment device used by an account holder. Each of the messages may include a token of a payment device tied to an external system and metadata. The token may be an alphanumeric string representing a payment device identifier. A listening engine may detect the messages as they are received by the messaging system. external system may be a retailer or service provider which stores and process payment devices (e.g., credit cards, debit cards, pre-paid debit cards, gift cards, or the like) in response to the account holder providing the payment device information and executing an event (e.g., sale, return, addition of payment device, deletion of payment device, deletion of an account, modification of the account or payment device, or the like) with the payment device using interface of external system. Each message may be generated based on an event affecting a token. Events may include addition, use, modification, suspension, deactivation, or deletion of the token.

In operation 404, an analyze engine may extract the token and the metadata from each of the messages. The analyze engine may read the messages and parse the message to detect and extract token and metadata from the messages. Metadata may include but is not limited to: payment device identifier, payment account reference, date and time stamp, token requestor ID, message type, token reference ID, device name, payment network identifier, secure element identifier, account hash, IP address of user device, user device location (latitude/longitude), user device ID, token status (e.g., active, deactivated, suspended, or inactive), token type, event type, reason code, and other relevant information.

In operation 406, the analyze engine validates a format of the token and metadata extracted from each message. For example, the metadata may include a date and the analyze engine may validate that the date is in the correct format.

In operation 408, the analyze engine may store token and metadata extracted from the message in a local vault. The local vault may be a self-contained secure environment. The analyze engine may make a call to the API of the local vault to interface with the local vault so that the analyze engine may store the token and metadata extracted from the message in the local vault. The local vault may correlate each event with the token affected by the event.

In operation 410, a time-series capture engine may capture the time-series token data for the token based on the metadata. The time-series token data may include events tied to the token. The time-series data may include all of the tokens generated for an account holder's payment device and token history detailing all of the events which affected each token.

In operation 412, a modeling engine may generate an analytical model using the time-series data. The analytical model may be used in predictive algorithms for forecast events. The analytical models may also be used in machine learning algorithms to detect events such as fraud or suspicious activity detection.

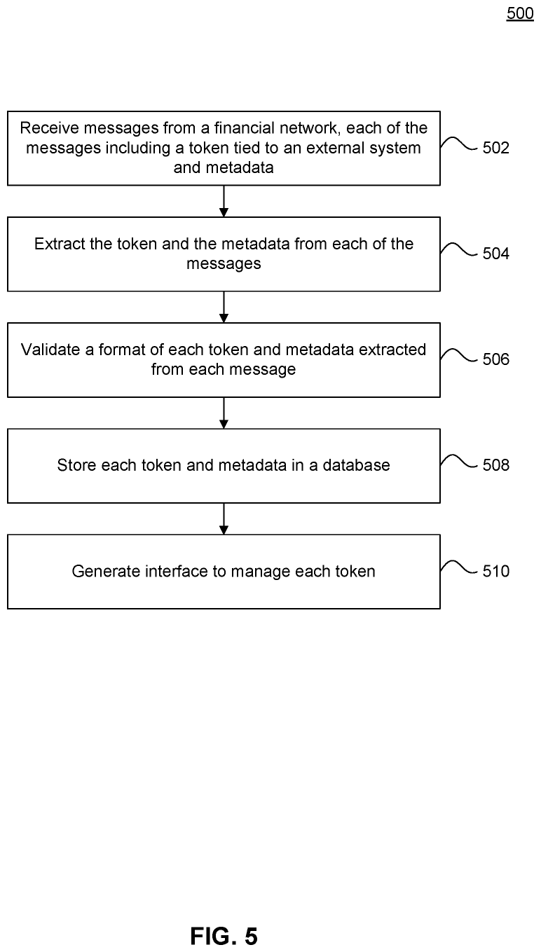

FIG. 5 is a flowchart 500 illustrating a process for generating an interface for managing token data. It is to be appreciated the operations may occur in a different order, and some operations may not be performed. Merely as an example, the flow of data will be described with respect to FIG. 1.

Flowchart 500 starts at operation 502. In operation 502, a messaging system may receive messages from a financial network. The messaging system may be hosted by a financial institution which is the issuer of a payment device used by an account holder. Each of the messages may include a token of a payment device tied to an external system and metadata. The token may be an alphanumeric string representing a payment device identifier. Each message may be generated based on an event affecting a token. The token may be generated by the external system and may be unique the external system.

In operation 504, an analyze engine may extract the token and the metadata from each of the messages. The analyze engine may read the messages and parse the message to detect and extract token and metadata from the messages.

In operation 506, the analyze engine may validate a format of the token and metadata extracted from each message.

In operation 508, the analyze engine may store token and metadata extracted from the message in a local vault. The local vault may be a self-contained secure environment. The analyze engine may make a call to the API of the local vault to interface with the local vault so that the analyze engine may store the token and metadata extracted from the message in the local vault. The local vault may correlate each event with the token affected by the event.

In operation 510, a local vault interface may generate GUIs for managing an account holder's token information. An account holder may use the local vault interface to add, modify, delete, suspend, or lock, a token tied to an external system. The account holder may also use the local vault interface to add a token, retrieve all tokens, retrieve a token for a specified external system, or retrieve token history for one or more external systems. The token history may include all of the events for a respective token tied to an external system.

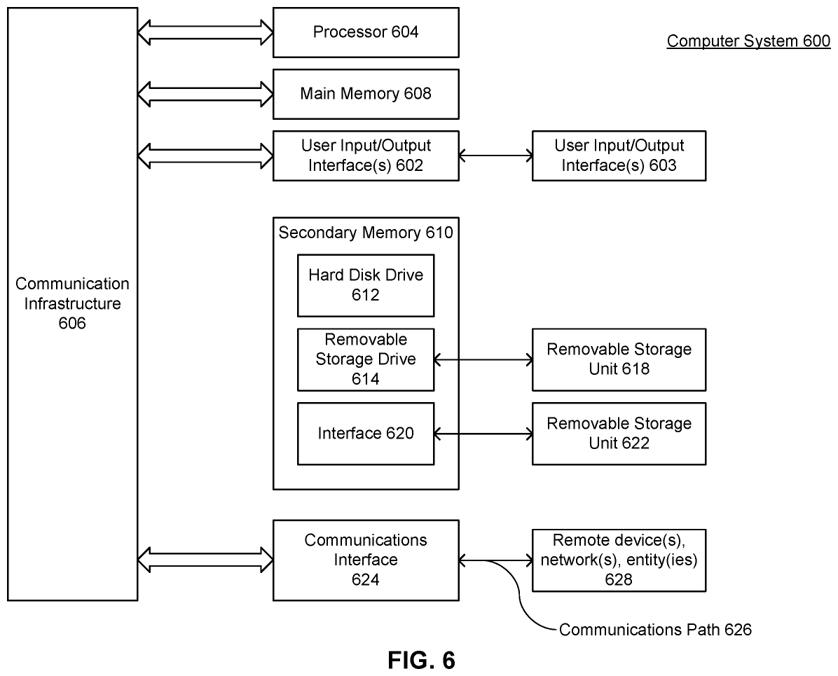

FIG. 6 is a block diagram of example components of device 600. One or more computer systems 600 may be used, for example, to implement any of the embodiments discussed herein, as well as combinations and sub-combinations thereof. Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614.

Removable storage drive 614 may interact with a removable storage unit 618. Removable storage unit 618 may include a computer usable or readable storage device having stored thereon computer software (control logic) and/or data. Removable storage unit 618 may be program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

1. A method for capturing time-series token data, the method comprising:
receiving, by one or more computing devices, messages from a financial network, each of the messages including a token included in the set of tokens tied to an external system of a set of external systems and metadata, wherein each token of the set of tokens corresponds with a different external system of the set of external systems;
extracting, by the one or more computing devices, the token and the metadata from each of the messages, by parsing each of the messages;
identifying, by the one or more computing devices, an event tied to the token based on the metadata from each of the messages;
storing, by the one or more computing devices, the token and metadata extracted from each message in a database residing in a self-contained environment, wherein the self-contained environment correlates each token of the set of tokens to a corresponding external system of the set of tokens;
capturing, by the one or more computing devices, time-series token data for the token based on the metadata of the token from the self-contained environment, wherein the time-series token data includes each of the events tied to the token;
generating, by the one or more computing devices, a time-series model using the time-series token data, the time-series model including events tied to the token as they occurred over a period of time;
receiving, by the one or more computing devices, a new message including the token and new metadata;
identifying, by the one more computing devices, a new event tied to the token based on the new metadata; and
identifying, by the one or more computing devices, fraud or suspicious activity based on the new event tied to the token based using the time-series model,
wherein the receiving, extracting, identifying, storing, capturing, generating, receiving, identifying, and identifying steps are performed by a system isolated from the self-contained environment.

2. The method of claim 1, wherein the token is an alphanumeric string representing a payment device identifier of an account holder.

3. The method of claim 1, further comprising validating, by the one or more computing devices, a format of the token and metadata prior to the storing.

4. The method of claim 1, wherein each of the messages is generated in response to an occurrence of each event of a plurality of events.

5. The method of claim 4, wherein the events comprise a modification of the token, an addition of the token, or a deletion of the token.

6. (canceled)

7. The method of claim 1, wherein the metadata comprises payment device identification number, payment device virtual number, token requester ID, token requester description, token type, token status, device information, location, provision information, deletion information, or IP address of the device.

8. (canceled)

9. The method of claim 1, further comprising rendering, the by one or more computing device, the token on a graphical user interface to manage the token,

10. A system for capturing time-series token data, the system comprising:
a memory;
a processor coupled to a memory, the processor configured to:
receive messages from a financial network, each of the messages including a token tied to an external system of a set of external systems and metadata, wherein each token of the set of tokens corresponds with a different external system of the set of external systems;
extract the token and the metadata from each of the messages, by parsing each of the messages;
identify an event tied to the token based on the metadata from each of the messages;
validate a format of each token and metadata extracted from each message;
store each token and metadata in a database residing in a self-contained environment, wherein the self-contained environment correlates each token of the set of tokens to a corresponding external system of the set of tokens;
capture the time-series token data for each token based on the metadata of the respective token, wherein the time-series token data includes events tied to each token
generate a time-series model using the time-series token data, the time-series model including events tied to the token as they occurred over a period of time;
receive a new message including the token and new metadata;
identify a new event tied to the token based on the new metadata; and
identify fraud or suspicious activity based on the new event tied to the token based using the time-series model,
wherein the system for capturing time-series token data is isolated from the self-contained environment.

11. The system of claim 10, wherein the token is an alphanumeric string representing a payment device identifier of an account holder.

12. The system of claim 10, wherein each of the messages is generated in response to an occurrence of each event of a plurality of events.

13. The system of claim 12, wherein the events comprise a modification of the token, an addition of the token, or a deletion of the token.

14. (canceled)

15. The system of claim 10, wherein the metadata comprises payment device identification number, payment device virtual number, token requester ID, token requester description, token type, token status, device information, location, provision information, deletion information, or IP address of the device.

16. (canceled)

17. A non-transitory computer readable medium storing instructions that when executed by one or more processors of a device cause the one or more processors to:
receive from a financial network, each of the messages including a token tied to an external system of a set of external systems and metadata, wherein each token of the set of tokens corresponds with a different external system of the set of external systems;
extract the token and the metadata from each of the messages, by parsing each of the messages;
identify an event tied to the token based on the metadata from each of the messages;
validate a format of each token and metadata extracted from each message;
store each token and metadata in a database residing in a self-contained environment, wherein the self-contained environment correlates each token of the set of tokens to a corresponding external system of the set of tokens; and
capture the time-series token data for each token based on the metadata of the respective token, wherein the time-series token data includes events tied to each token;
generate a time-series model using the time-series token data, the time-series model including events tied to the token as they occurred over a period of time;
receive a new message including the token and new metadata;
identify a new event tied to the token based on the new metadata; and
identify fraud or suspicious activity based on the new event tied to the token based using the time-series model,
wherein the receiving, extracting, identifying, storing, capturing, generating, receiving, identifying, and identifying operations are performed by a system isolated from the self-contained environment.

18. The non-transitory medium of claim 17, wherein the token is an alphanumeric string representing a payment device identifier of an account holder.

19. The non-transitory medium of claim 16, wherein each of the messages is generated in response to an occurrence of each event of a plurality of events.

20. The non-transitory medium of claim 19, wherein the events comprise a modification of the token, an addition of the token, or a deletion of the token.
